(19) United States
(12) Patent Application Publication
(10) Pub. No.: US 2003/0210963 A1
(43) Pub. Date: Nov. 13, 2003

(54) Rotary tool and cutting part comprised in the tool

(75) Inventors: Isak Kakai, Gavle (SE); Lars-Gunnar Wallstrom, Sandviken (SE)

Correspondence Address: BURNS, DOANE, SWECKER & MATHIS, L.L.P., P.O. Box 1404, Alexandria, VA, 22313-1404, US

(73) Assignee: SANDVIK AB, Sandviken (SE)

(21) Appl. No.: 10/392,897

(22) Filed: Mar. 21, 2003

(30) Foreign Application Priority Data
Mar. 21, 2002 (SE) 0200852-2

(51) Int. Cl. B23B 51/00

(52) U.S. Cl. 408/231

(57) ABSTRACT

A rotary tool for chip removing machining, for example a milling cutter or a drill, includes a shaft, a holder, and a cutting part. The shaft has a conical seating arranged in its front end. The holder has a slightly conical recess, whose cross-sectional dimension decreases toward the open end of the recess. The cutting part has a slightly conical pin designed to be received in the recess and has a cross-sectional dimension which increases in the direction of the free end of the pin. The recess is formed by a wall which is elastically flexible in a radial direction. When the holder is drawn axially into the seating, the wall is flexed radially inwardly, causing the conical surface of the recess to tightly grip the conical surface of the pin and create an interference fit of the pin in the recess.

This application claims priority under 35 U.S.C. §119 to Patent Application Serial No. 0200852-2 filed in Sweden on Mar. 21, 2002, the entire content of which is hereby incorporated by reference.

### TECHNICAL FIELD OF THE INVENTION

The present invention relates to a rotary tool, especially for chip removing machining, the tool, for instance, being a milling cutter or a drill and comprising a shaft, and a conical seating arranged in the shaft. The seating is situated in connection to one end of the shaft. A holder has an externally generally conical portion and members for receipt of a cutting part, as well as members which apply a force on the holder in the axial direction of the shaft. Separately, the invention also relates to a cutting part that constitutes a replaceable part of the tool according to the present invention.

### PRIOR ART

A modular milling system is previously known from the company SILMAX, which system is marketed under the trademark SHUTTLE SYSTEM. The system comprises a spindle, which has an axial through-hole, in which a drawbar is arranged. The drawbar is provided with an externally threaded portion at one end thereof, which is designed to interact with an internally threaded, axially slotted sleeve that is externally conical. On mutual rotation of the drawbar and the slotted sleeve, the same will be displaced axially in relation to each other. On the outside thereof, the slotted sleeve interacts with a conical seating. In addition, the slotted sleeve has an internal, generally cylindrical part that is designed to interact with a cylindrical pin of a replaceable cutter head that is part of the milling system. This replaceable cutter head is preferably made of solid cemented carbide. When the slotted sleeve is displaced axially in the conical seating thereof, the sleeve will be pressed around the pin of the cylindrical cutter head, whereby the cutter head becomes fixed in the spindle. In that connection, it should be noted that on clamping the cutter head in the slotted sleeve, interaction between cylindrical surfaces takes place.

A tool is previously known from EP 0 776 719-A1, which tool has a replaceable cutting head, the cutting head being provided with a shoulder, a conical part as well as a male part that is designed to form part of a type of dovetail coupling. A shank of the tool has a stop face, a conical seating and an internal thread, which interacts with an external thread of a holder, which furthermore has a female part that is designed to be integral with the dovetail coupling. On mounting of the cutting head, the same is rotated, preferably by means of a key, the shoulder of the cutting head coming in abutment with the stop face of the shaft in the main at the same time as the cone-shaped part of the cutting head comes into abutment with the conical seating of the shaft. The problem is that the tolerances do not permit that this be carried out exactly simultaneously, which means that abutment will occur either between the shoulder and the stop face or between the conical part and the conical seating.

### SUMMARY OF THE INVENTION

A primary aim of the present invention is to provide a rotary tool of the kind defined in the introduction, which has a good stability despite the cutter head being dismountable.

Yet another aim of the present invention is that the rotary tool should maintain acceptable tolerances as for the chip removing machining carried out by means of the rotary tool according to the present invention.

Another aim of the present invention is that according to a preferred embodiment the members for fixation of the dismountable cutter head should have a relatively short extension in the axial direction of the tool.

The invention relates to a rotary tool for chip removing machining which comprises a shaft, a holder, and a cutting part. The shaft defines a longitudinal axis and has an axially outwardly open seat disposed adjacent a free end of the shaft. The seat is defined by a conical seat surface whose cross-sectional dimension decreases in an axially inward direction. The holder is mounted in the seat and includes a wall defining an axially outwardly open recess. The recess is defined by a conical inner surface of the wall, wherein a cross-sectional dimension of the inner wall decreases in an axially outward direction. The wall includes a conical outer surface which is engageable with the seat surface. A cross-sectional dimension of the outer wall decreases in an axially outward direction. The holder is insertable into the seat along the axis to bring the outer surface of the wall into engagement with the seat surface. The wall is elastically flexible in a generally radially inward direction during axially inward insertion of the holder. The cutting part includes a pin having a conical pin surface whose cross-sectional dimension decreases in an axially outward direction. The pin is disposed in the recess wherein the pin surface is tightly gripped by the inner surface of the recess in response to the inward flexing of the wall.

Another aspect of the invention relates to a cutting part which comprises a head that includes cutting edges at a front end thereof for chip removing machining. The cutting part further includes a pin projecting from a rear end of the head. The pin includes an outer surface which is conical with a cross-sectional dimension decreasing in a direction away from a free end of the pin.

### BRIEF DESCRIPTION OF THE DRAWINGS

The objects and advantages of the invention will become apparent from the following detailed description of a preferred embodiment thereof in connection with the accompanying drawing in which like numerals designate like elements, and in which

FIG. 1 shows an exploded view of the components of which the tool is composed, where a shaft comprised in the tool is sectioned in the longitudinal direction thereof.

FIG. 2 shows a perspective view obliquely from below of a cutting part which forms part of the tool according to FIG. 1.

FIG. 3 shows a perspective view obliquely from above of a holder, which forms part of the tool according to FIG. 1.

FIG. 4 shows in an exploded view a longitudinal section through the tool according to FIG. 1.

FIG. 5 shows a longitudinal section through the tool according to FIG. 1 when the various components of the tool are assembled, i.e. the tool is ready to be used.

FIG. 5A is a perspective view of a cutting part having integral cutting edges.

FIG. 6 shows a longitudinal section through an alternative embodiment of the tool according to the present invention.

FIG. 7 shows an alternative embodiment of a cutting part which is included in the tool according to the present invention.

FIG. 8 shows an alternative embodiment of a holder that fits to the cutting part according to FIG. 7 and is included in the tool according to the present invention.

### DESCRIPTION OF PREFERRED EMBODIMENTS OF THE INVENTION

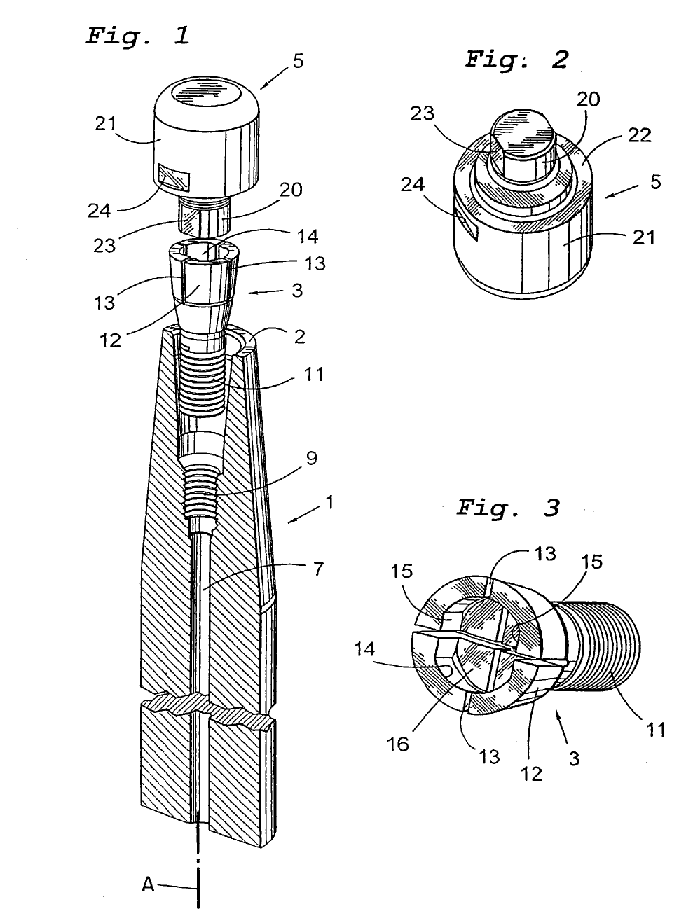

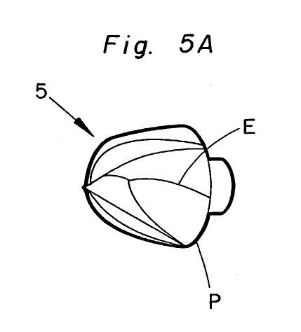

The rotary tool for chip removing machining according to the present invention shown in FIGS. 1, 4 and 5 comprises a shaft 1, a holder 3 as well as a cutting part 5. The shaft 1 has an end face 2 at a free end thereof. The upper portion of the cutting part 5 is only shown schematically in these figures, i.e. cutting edges, chip channels and the like are not illustrated. A cutting part 5 is shown in FIG. 5A having integral cutting edges E and chip passages P. Alternatively, the cutting part could have cutting edges formed by replaceable cutting inserts (not shown).

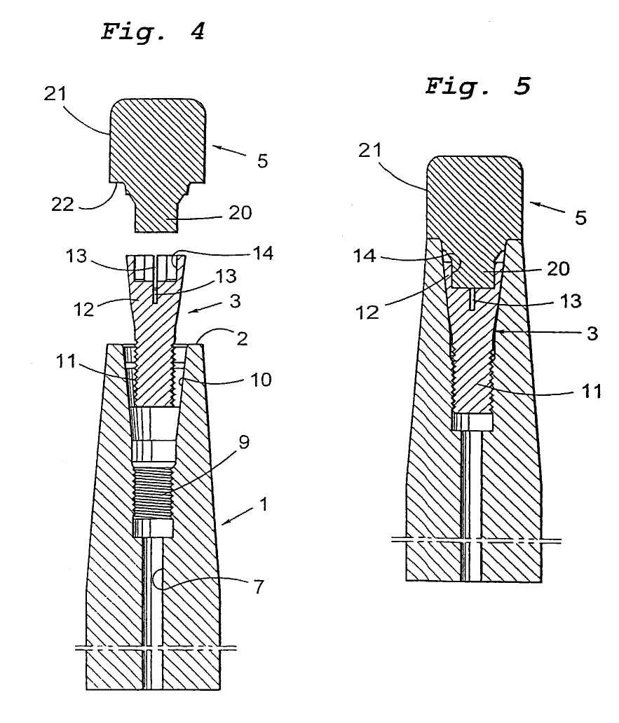

The shaft 1 defines a longitudinal axis A and is provided with a through hole 7 extending axially. As is most clearly seen in FIG. 4, at the free end that will receive the holder 3 and the cutting part 5, the shaft 1 is provided with an internal thread 9 as well as an axially outwardly open, cone-shaped seating 10 situated outside of this thread 9 and at a free end of the shaft. The seating is formed by a surface whose cross-sectional dimension decreases in a direction away from the free end of the shaft, i.e., in an axially inward direction. The internal thread 9 is situated directly adjacent to the through hole 7.

The holder 3 has an externally threaded portion 11 as well as a fixing portion 12, defined by a wall which has an axially outwardly facing surface in which are formed four slots 13. The slots extend axially for approximately half the height of the holder 3. The fixing portion 12 is generally cone-shaped at the outside thereof, whereby the external cross-section dimension of the fixing portion 12 increases in the direction from the externally threaded portion 11. Inside the fixing portion 12, a generally slightly conical recess 14 is arranged, the recess 14 formed by an inner surface of the holder and having a cross-sectional dimension which decreases in an axially outward direction, i.e., toward the free end of the recess 14. In addition, the inner surface has two opposite first planar surfaces 15, which converge slightly towards each other in the direction of the open end of the recess 14 and which define a non-circular cross-section of the recess. The slots 13 have an axial extension past the bottom 16 of the recess 14, see FIG. 4. The wall of the fixing portion 12 also includes a conical outer surface whose cross-sectional dimension decreases in an axially inward direction. The outer surface is thus configured to engage the surface of the seating 10. Each slot 13 extends radially from the outer surface to the inner surface and render the wall to be elastically flexible in a generally radial direction.

The cutting part 5 has a pin 20 and a head 21 which is just schematically shown, i.e. cutting edges and other components included in the cutting geometry are omitted. In the transition between the pin 20 and the head 21, the cutting part 5 is provided with a rear end defining a radially oriented annular shoulder 22, which in the mounted position will get into abutment with an end face 2 of the shaft 1.

The pin 20 included in the cutting part 5 forms a pin surface which is generally slightly conical, having a cross-sectional dimension which increases in an axially inward direction, i.e., toward the free end of the pin 20. The conicity of the pin 20 is adapted to the conicity of the recess 14, this being explained in more detail in connection with the description below as to how the components of the tool according to the present invention interact. The pin 20 also has two diametrically located second planar surfaces 23, which diverge slightly towards each other in the direction of the head 21.

The cutting part 5 also has a key recess 24, by means of which the cutting part 5 may be brought to rotate.

In FIGS. 1 and 4, exploded views of the components included in the tool according to the present invention are shown. These components are to be connected mutually in such a way that the tool shown in FIG. 5 is obtained. In order to effect this, the pin 20 of the cutting part 5 is pushed into the slotted fixing portion 12 of the holder 3. In that connection, the second planar surfaces 23 of the pin 20 are brought to be located exactly opposite the first planar surfaces 15 of the recess 14. This is necessary in order to enable the pin 20 to be pushed into the recess 14. At this stage the fixing portion 12 is unloaded, something which also is a prerequisite in order to enable the pin 20 to be pushed into the recess 14.

The conicity of the pin 20 is adapted to the conicity of the recess 14, whereby an important objective is to attain the best possible agreement of the conicities when the components are fully connected with each other, which is shown in FIG. 5.

After the pin 20 of the cutting part 5 has been pushed into the recess 14, the externally threaded portion 11 of the holder 3 is inserted into the shaft 1 and into engagement with the internal thread 9. This is achieved by rotating the cutting part 5 and the holder 3, which is accomplished pressing a key (not shown) into the key recess 24 of the head 21 of the cutting part 5. On rotation of the cutting part 5, the holder 3 is driven due to the fact that the planar surfaces 15 and 23 of the recess 14 and the pin 20, respectively, interact. The screw thread arrangement defined by the threads 9 and 11 thus defines a holder-displacement means.

When the externally threaded portion 11 has reached a distance into the internal thread 9, the cone-shaped, external part of the fixing portion 12 will come into contact with the cone-shaped seating 10 of the shaft 1. On continued displacement axially inwards in the shaft 1 of the holder 3 and the cutting part 5, the fixing portion 12 of the holder 3 will become somewhat deformed since this portion is provided with axially extending slots 13. The deformation is effected by the contact between the cone-shaped seating 10 and the cone-shaped, external part of the fixing portion 12.

On continued rotation of the cutting part 5, a closer contact will be established between the cone-shaped seating 10 and the cone-shaped, external part of the fixing portion 12. In that connection, the deformation will progress and the fixing portion 12 will be pressed around the pin 20, something which is made possible by virtue of the presence of the axially extending slots 13. When the cutting part 5 is finally mounted in the shaft 1, the shoulder 22 of the head 21 will come to abutment with the end face 2 of the shaft 1. Thereby, an exceptionally safe mounting of the cutting part 5 in the shaft 1 is obtained, the joint between the cutting part 5 and the shaft 1 in a satisfactory way carrying the loads that the cutting part 5 is subjected to, for instance bending loads. In the final position of the holder 3 inside the shaft 1, see FIG. 5, the pin 20 is fixed inside the recess 14, whereby the conicity of the pin 20 should correspond to the conicity of the recess 14. Since the recess 14 and the outer surface of the pin 20 have cross-sectional dimensions that decrease in an axially outward direction, a positive interference fit will be established for holding the cutting part which is more robust and reliable than a pure frictional-fit.

When a cutting part 5 of the tool according to the present invention is worn out, the same is dismounted in the opposite way as a cutting part 5 is mounted. In that connection, by means of the key, the cutting part 5 is rotated in the opposite direction in comparison to that used when mounting the cutting part, the holder 3 being conveyed and the externally unthreaded portion 11 being threaded out of the internal thread 9. When the worn out cutting part 5, together with the holder 3, has been removed from the shaft 1, the cutting part 5 can be removed from the holder 3. After that, a new fresh cutting part 5 is attached in the holder 3 by the pin 20 being pushed into the recess 14 of the holder 3 in the way that has been described above. The mounting of the cutting part 5, together with the holder 3, now continues in a corresponding way as has been described above.

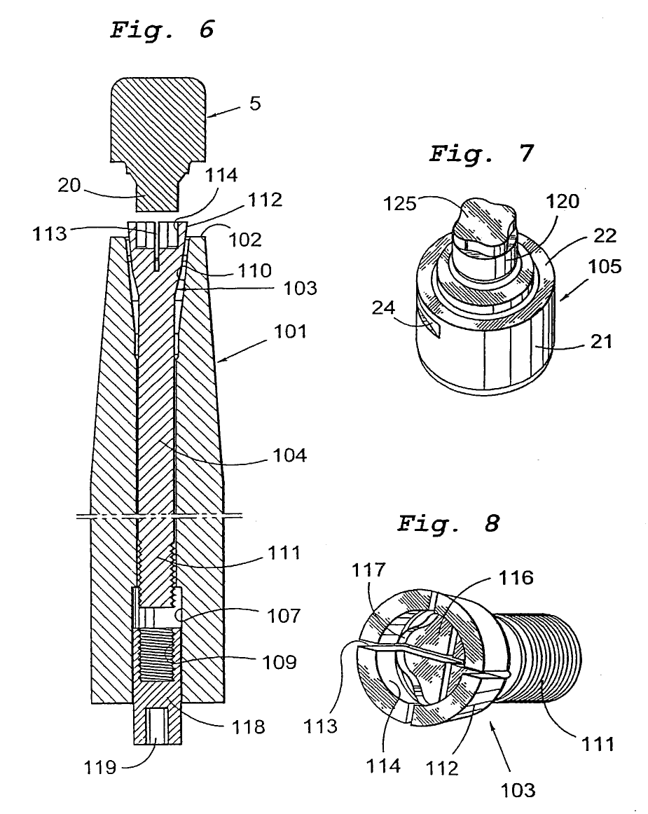

In FIG. 6, a longitudinal section through a tool according to the present invention is shown. Principally, the tool according to FIG. 6 differs from the tool according to FIGS. 1, 4 and 5 by the holder 103 being integrated with a drawbar 104, which has an externally threaded portion 111 at the end turned from the holder 103. A through hole 107 is arranged in the shaft 101, in which hole the drawbar 104 is housed, with a sleeve 118, provided with an internal thread 109, being arranged in the through hole 107. The sleeve 118 also has a key recess 119 at the end facing away from the thread 109. This internal thread 109 is designed to interact with the externally threaded portion 111 of the drawbar 104 by sleeve 118 being rotated, preferably by means of a hex socket wrench that is applied into the key recess 119. In that connection, the drawbar with the fixing portion 112 thereof will move axially such that a corresponding interaction as in the above-described embodiment arises. In order to effect axial movement of the drawbar, rotation of the drawbar is prevented, e.g., by friction between the surfaces 110, 112, and/or by providing a non-circular cross-sectional shape for a portion of the drawbar that engages a corresponding non-circular cross-section of the shaft 1. It will be appreciated that the screw thread arrangement 109, 111 defines a holder displacement means.

Regarding the fixing portion 112 of the holder 103 in the embodiment according to FIG. 6, it is formed in a principally equivalent way as the fixing portion 12, i.e. it is provided with axially extending slots 113 as well as a conical recess 114.

The cutting part 5 shown in FIG. 6 is identical with the cutting part 5 in the above-described embodiment. This implies that the pin 20 of the cutting part 5 interacts with the recess 114 on mounting of the cuffing part 5 in a principally corresponding way as has been described above in connection with the embodiment according to FIGS. 1, 4 and 5. The corresponding applies when a worn out cutting part 5 is to be dismounted in the tool according to FIG. 6.

In FIG. 7, an alternative embodiment of a cutting part 105 included in the tool according to the present invention is shown, which is to be used together with a holder 103 shown in FIG. 8. The cutting part 105 primarily differs from the above-described cutting part 5 by the design of the pin 120, i.e. the head 21 of the cutting part 105 may be identical with the head 21 of the cutting part 5. In a corresponding way as in the cutting part 5, the pin 120 of the cutting part 105 is slightly conical, however it does not have any planar surfaces in the conical envelope surface. The pin 120 has a quadrangle 125 at the free end thereof, which in the embodiment illustrated has rounded corners. The cross-sectional dimension of the quadrangle 125 between diametrically situated corners substantially equals the diameter of the pin 120 at the free end thereof, i.e. where the quadrangle 125 connects to the pin 120. Preferably, the quadrangle 125 is formed integrally with the pin 120. In the embodiment illustrated, the quadrangle 125 is of an essentially lesser axial extension than the pin 120.

In FIG. 8, the alternative embodiment of a holder 103 included in the tool according to the present invention is shown, said holder 103 primarily differing from the above-described holder 3 by the design of the recess 114 of the fixing portion 112, i.e. the externally threaded portion 11 of the holder 103 may be identical with the externally threaded portion 11 of the holder 3.

The recess 114 has a bottom pocket 116 that has a border 117 running around the circumference, which border in planar view of the bottom pocket 116 has a quadrangular shape that equals the circumference of the quadrangle 125. In general, the border 117 and the quadrangle 125 have a substantially similar axial extension.

When the pin 120 of the cutting part 105 is pushed into the recess 114, it should be ensured that the quadrangle 125 fits shapeless into the pocket that is defined by the border 117. After that, the cutting part 105 and the holder 103 are mounted in a shaft, which may be identical with the shaft 1 according to FIGS. 1, 4 and 5. When the cutting part 105 is rotated, the holder 103 is also rotated due to the fact that the quadrangle 125 interacts with the border 117. As regards the clamping of the pin 120 in the recess 114, it is carried out in principally the corresponding way as in the above-described embodiment. Dismounting of the cutting part 105 is also carried out in principally the corresponding way as in the above-described embodiment.

For both of the above-described embodiments, the term “slightly conical” has been applied concerning the conicity of both the recess 14; 114 and the pin 20; 120. By this term, it should be appreciated a cone angle that is larger than 0° and less than or equal to (i.e., no greater than) about 5°.

Feasible Modifications of the Invention:

In the above-described embodiments, the fixing portion 12; 112 of the holder 3; 103 is provided with four axially extending slots 13; 113. Within the scope of the present invention, it is, however, conceivable that the fixing portion is provided with fewer or more slots than four.

In the above-described embodiment of the cutting part 105 according to FIG. 7 and the holder 103 according to FIG. 8, the cutting part 105 has a quadrangle 125 and the pocket 116 has a quadrangular border 117 adapted to the quadrangle. However, within the scope of the present invention also other geometrical shapes of the element arranged at the free end of the pin and the border adapted to this element are conceivable. With an exemplifying and not limiting view, a triangle, a pentagon or a hexagon can be mentioned. In this connection, it is however important that the pin can easily be mounted in the recess so that a satisfactory engagement occurs, which engagement guarantees mutual conveyance between the cutting part and the holder.

In the above-described embodiments of a tool for chip removing machining, the shaft 1; 101 has a through hole 7; 107, which is designed to be used as a cooling duct. However, within the scope of the present invention it is also conceivable that the hole 7; 107 be omitted and that cooling is achieved in another way.

In the above-described embodiments, the holder 3, 103 is made in one piece. However, within the scope of the present invention it is also conceivable that the fixing portion 12; 112, for instance, is made out of cemented carbide while the rest of the holder 3; 103 is made out of steel.

Although the present invention has been described in connection with preferred embodiments thereof, it will be appreciated by those skilled in the art that additions, deletions, modifications and substitutions may be made without departing from the spirit and scope of the invention as defined in the appended claims.

What is claimed is:

1. A rotary tool for chip removing machining, comprising:
a shaft defining a longitudinal axis and having an axially outwardly open seat disposed adjacent a free end of the shaft, the seat defined by a conical seat surface whose cross-sectional dimension decreases in an axially inward direction;
a holder mounted in the seat and including a wall defining an axially outwardly open recess, the recess defined by a conical inner surface of the wall, wherein a cross-sectional dimension of the inner wall decreases in an axially outward direction, the wall including a conical outer surface engageable with the seat surface, a cross-sectional dimension of the outer wall decreasing in an axially inward direction, the holder being insertable into the seat along the axis to bring the outer surface of the wall into engagement with the seat surface, the wall being elastically flexible in a generally radially inward direction in response to such engagement during axially inward insertion of the holder; and
a cutting part including a pin having a conical pin surface whose cross-sectional dimension decreases in an axially outward direction, the pin disposed in the recess wherein the pin surface is tightly gripped by the inner surface of the recess in response to the inward flexing of the wall.

2. The rotary tool according to claim 1 further including holder-displacement means for axially displacing the holder into the seat.

3. The rotary tool according to claim 2 wherein the holder-displacement means comprises a screw thread arrangement.

4. The rotary tool according to claim 1 wherein the holder and the shaft have interconnected screw threads for displacing the holder axially into the seat in response to rotation of the holder in one direction.

5. the rotary tool according to claim 1 further including a sleeve connected to an end of the holder disposed opposite the recess by a screw thread arrangement, wherein rotation of the sleeve relative to the holder is one direction causes the holder to be displaced axially into the seat.

6. The rotary tool according to claim 1 wherein the wall includes an axially outwardly facing end surface in which slots are formed that extend from the inner surface of the wall to the outer surface of the wall, to render the wall elastically flexible in the generally radial direction.

7. The rotary tool according to claim 1 wherein the pin and the recess include inter-engaging structure preventing rotation of the cutting part relative to the holder about the axis.

8. The rotary tool according to claim 7 wherein the inner surface of the wall includes a first portion of non-circular cross section, and the pin includes a second portion of non-circular cross section engaging the first portion.

9. The rotary tool according to claim 7 wherein the first portion comprises a pocket of quadrangular shape, and the second portion comprises a quadrangular projection fitting with the pocket.

10. The rotary tool according to claim 7 wherein the cutting part includes a generally radially oriented shoulder arranged to abut against an axially outwardly facing end face of the shaft.

11. The rotary tool according to claim 1 wherein the conical surface of the wall and the conical pin surface define a cone angle no greater than about 5 degrees.

12. A cutting part comprising a head including cutting edges at a front end thereof for chip removing machining, and a pin projecting from a rear end of the head, the pin including an outer surface which is conical with a cross-sectional dimension decreasing in a direction away from a free end of the pin, the cutting part forming a rearwardly facing shoulder.

13. The cutting part according to claim 12 wherein the shoulder is formed by the rear end of the head.

14. The cutting part according to claim 12 wherein the outer surface of the pin defines a cone angle no greater than about 5 degrees.
